(19) United States
(12) Patent Application Publication
(10) Pub. No.: US 2019/0227296 A1
(43) Pub. Date: Jul. 25, 2019

(54) Detachable Supplementary Viewing Accessory for a Scope Device

(71) Applicants: Cheston Davis, Beaver, UT (US); Shane Kerksiek, Beaver, UT (US)

(72) Inventors: Cheston Davis, Beaver, UT (US); Shane Kerksiek, Beaver, UT (US)

(21) Appl. No.: 15/989,911

(22) Filed: May 25, 2018

Related U.S. Application Data
(60) Provisional application No. 62/619,852, filed on Jan. 21, 2018.

(51) Int. Cl. G02B 23/14; G02B 23/04; G02B 23/16

(52) U.S. Cl. CPC G02B 23/14; G02B 23/16; G02B 23/04

(57) ABSTRACT

A detachable supplementary viewing accessory for a scope device is shown and described. The accessory has a beam splitter and is mounted in-line with a first optical path of the accessory so that ordinary viewing may be performed with the scope. A reflected second beam travels along a second optical path to be accessible to a camera or other external image using device which may be held by a dock which is part of the accessory. Distance from the dock to the beam splitter is adjustable to assure a good image is available at the dock. The accessory has a variable geometry mount for accommodating scopes of different configurations. The mount may have a saddle to stabilize seating on the scope.

### CROSS-REFERENCE TO RELATED APPLICATION

This application claims priority to U.S. Provisional Utility Application Ser. No. 62/619,852 filed Jan. 21, 2018, the contents of which are incorporated by this reference.

### FIELD OF THE INVENTION

The present invention relates to viewing devices such as gun scopes, telescopes, microscopes, medical viewing equipment such as endoscopes, and spotting scopes, and more particularly to a manually installable accessory device enabling a view visible from the scope to be seen simultaneously at two different locations or from two different directions.

### BACKGROUND OF THE INVENTION

Scope devices, such as gun scopes, enable a user to view an object visible in the scope advantageously. However, scopes are designed to accommodate only the user. It may be desirable to enable a second party to see what is being viewed by the user. Additionally, it may be desirable to enable a camera to record what is being viewed by the user simultaneously with the user using the scope. There exists a need for an adapting device to manifold an optical image beam into plural beams to accommodate more than one observer at a time.

### SUMMARY OF THE INVENTION

The present invention provides an accessory which manifolds an optical image beam in a scope device into plural beams for simultaneous use by both a user of a scope device and also, an observer or a camera or recording device looking at an image identical to that seen by the user.

The accessory includes a housing containing a beam splitting glass, and having first and second viewing ports for the respective split beams. The first viewing port enables conventional use of the scope device by the user. That is, the user's eye orientation is directly into and in line with a conventional optical path of the scope. The second viewing port is arranged at an oblique or right angle to the conventional optical path. The second viewing port may be used by a human user, or may accommodate a camera or other optical device using the image seen by the user.

The housing of the beam splitting glass is secured to the scope by a mount of variable geometry, and may comprise a flexible strap for example. The flexible strap may be retained tightly to the scope by a ratchet mechanism.

A saddle may be provided at the mount to stabilize the latter on the scope.

The present invention provides improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is an environmental, rear perspective view of a detachable supplementary viewing accessory mounted to a scope of a rifle;

FIG. 2 is an exploded perspective of the detachable supplementary viewing accessory shown in FIG. 1; and

FIG. 3 is an environmental, diagrammatic, top plan view of the detachable supplementary viewing accessory of FIG. 1, shown with a user and an observer.

### DETAILED DESCRIPTION

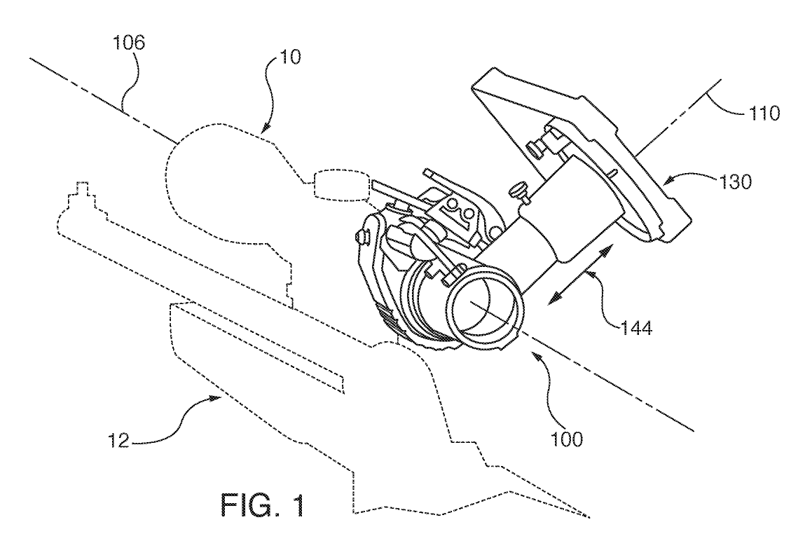

Referring first to FIG. 1, according to at least one aspect of the invention, there is shown a detachable supplementary viewing accessory 100 mounted to a scope device such as a scope 10 of a rifle 12. Hereinafter, because only one type of scope device is illustrated, when referring to the attached drawing figures, the scope and the scope device will both be designated with reference numeral 10. Detachable supplementary viewing accessory 100 enables a user (not shown) to view images visible in scope 10, as well as enabling a camera device such as a smartphone (not shown) to receive images simultaneously.

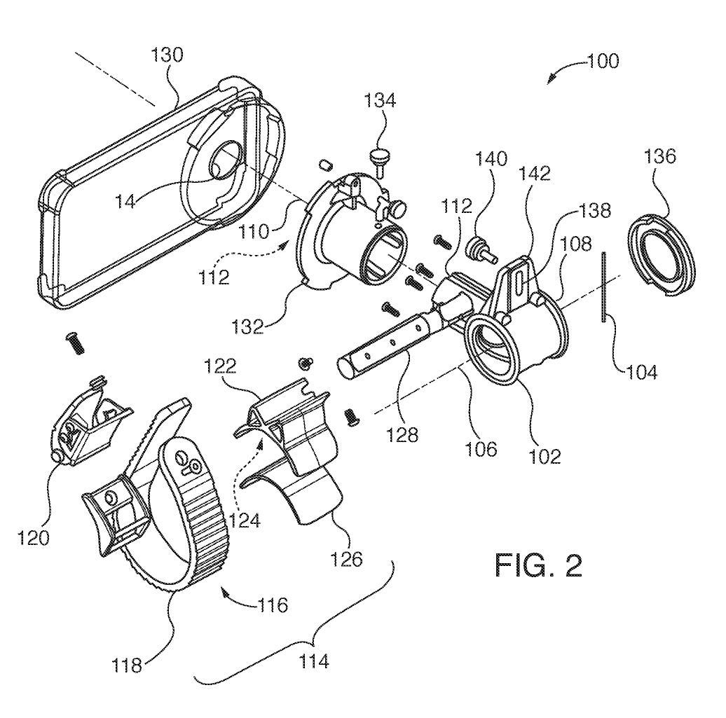

Referring primarily to FIG. 2 but also to FIG. 1, detachable supplementary viewing accessory 100 for a scope device may comprise a housing 102 containing a splitter beam glass 104 and including a straight first optical path 106, a first viewing port 108 affording a view of first optical path 106, a second optical path 110 arranged at a right angle or an oblique angle to first optical path 106, and a second viewing port 112 affording a view of second optical path 110. First optical path 106 and second optical path 110 diverge at splitter beam glass 104 and provide identical views. Detachable supplementary viewing accessory 100 may also comprise a mount 114 attachable to housing 102 and may include a connector adapted to secure housing 102 to scope device 10. The connector may have a grasping element capable of engaging and tightening over scopes 10 of different dimensions.

Unless otherwise indicated, the terms “first”, “second”, etc., are used herein merely as labels, and are not intended to impose ordinal, positional, or hierarchical requirements on the items to which these terms refer. Moreover, reference to, e.g., a “second” item does not either require or preclude the existence of, e.g., a “first” or lower-numbered item, and/or, e.g., a “third” or higher-numbered item.

First and second optical paths 106, 110 are pictorially represented by lines, but will be understood to be two dimensional, enabling two dimensional images to be conveyed. First optical path 106 is generally concentric with an optical path of scope 10, allowing for minor misalignments between the two. Identical views of first and second optical paths 106, 110 refers to content. Light in first and second optical paths may vary in intensity, depending upon reflectance and transmissivity characteristics of splitter beam glass 104. In an example, splitter beam glass 104 may be selected such that seventy percent of light is transmitted along first optical path 106, while thirty percent of light is reflected to propagate along second optical path 110. In the depiction of FIGS. 1 and 2, first optical path 106 may be at a right angle to second optical path 110. Other angles are possible, depending on orientation of splitter beam glass 104 within housing 102.

In the example of FIGS. 1 and 2, in detachable supplementary viewing accessory 100 of claim 1, the grasping element may comprise a flexible strap 116 configured to engage scope 10 by encirclement. Flexible strap 116 may include ratchet teeth 118. Mount 114 may comprise a ratchet mechanism 120 adapted to retain flexible strap 116 on scope 10 unless manually released. Mount 114 may further comprise a saddle 122 having an abutment surface 124 abutting scope 10 when detachable supplementary viewing accessory 100 is mounted to scope 10. Saddle 122 may be is attachable directly or indirectly to housing 102. Saddle 122 seats against scope 10 for stability of viewing. To further improve stability of saddle 122 relative to scope 10, detachable supplementary viewing accessory 100 may further comprise a deformable cushion 126 lining abutment surface 124 of saddle 122, for improving conformity of saddle 122 with an external surface of scope 10 when detachable supplementary viewing accessory 100 is mounted to scope 10. Cushion 126 may have adhesive (not shown) applied thereto, to improve grip of mount 114, and to oppose unintended rotation of detachable supplementary viewing accessory 100 about scope 10. Cushion 126 may be fabricated from rubber or a similar material.

Detachable supplementary viewing accessory 100 may further comprise a rigid support bar 128 attachable to saddle 122 and to housing 102, and configured to space mount 114 away from housing 102 along first optical path 106. Support bar 128 also enables housing 102 and first viewing port 108 to be located behind mount 114. As employed herein, “behind” signifies that the object so described (e.g., first viewing port 108) is on that side of the reference object (e.g., mount 114) opposite the object being observed using scope 10.

Detachable supplementary viewing accessory 100 may further comprise a dock 130 for an electronic communications device (not shown) having a camera. Dock 130 is located and configured such that light from second optical path 110 will enter the camera. The electronic communications device may be a smartphone or video camera for example. As illustrated, dock 130 configured to receive and support a smartphone, with a camera opening 14 aligned with second optical path 110.

It may be mentioned here that installing an electronic communications device may terminate second optical path 110 by interference. In the absence of such a device, second optical path 110 may be said to continue indefinitely, as indicated in FIG. 2.

If dock 130 were installable in only one location along second optical path 110, it would be possible to introduce optical distortions such as poor focus interfering with effective viewing. To forestall this, detachable supplementary viewing accessory 100 may further comprise an adapter 132 configured to slide along second viewing port 112 (or structure defining the same) and to thereby adjust proximity of dock 130 from second viewing port 112. This adjustment is represented by arrow 144 in FIG. 1. It will be appreciated that first and second viewing ports 108, 112 may be interpreted to encompass tubular structure surrounding respective first and second optical paths 106, 110, or alternatively, may refer only to the very end of the tubular structure, depending upon context.

Detachable supplementary viewing accessory 100 may further comprise a securement element adjustable to lock adapter 130 at a selected location along second viewing port 112. The securement element may include a setscrew 134 functional to clamp adapter 130 to second viewing port 112.

Detachable supplementary viewing accessory 100 may further comprise a dust cap 136 removably attachable to first viewing port 108 by snap fit, for example.

Detachable supplementary viewing accessory 100 may further comprise a housing positional adjustment feature enabling housing 102 be centered on scopes 10 of different dimensions. In the example of detachable supplementary viewing accessory 100 illustrated herein, detachable supplementary viewing accessory 100 may further comprise a rigid support bar 128 attachable to 122 saddle and to housing 102, and configured to space mount 114 away from housing 102, wherein the housing positional adjustment feature comprises a long hole 138 formed in one of support bar 128 and housing 102, and a setscrew 140 configured to pass through long hole 138 and to thread into the other one of support bar 128 and housing 102. In the illustrated example, long hole 138 is formed in a tab 142 of housing 102. In this example, setscrew 140 passes through a bore in support bar 128 and threads into tab 142.

In FIG. 2, a certain number of screws are shown but not identified by reference numerals. These screws enable components of detachable supplementary viewing accessory 100 to be detachably assembled to one another. Although components may be connected or assembled to one another in any desired way, such as by gluing, thermal welding, etc., threaded fasteners are shown herein. Fasteners are removable by hand (e.g., where shown with an enlarged head, such as is seen with setscrew 140), thereby making the associated component both manually attachable and manually detachable. As employed herein, “manually” will be understood to encompass by the use of hands only, or by the use of simple, handheld tools. FIG. 2 shows the unidentified screws axially aligned with corresponding threaded holes, to facilitate understanding of how the various components of detachable supplementary viewing accessory 100 may be mutually attached.

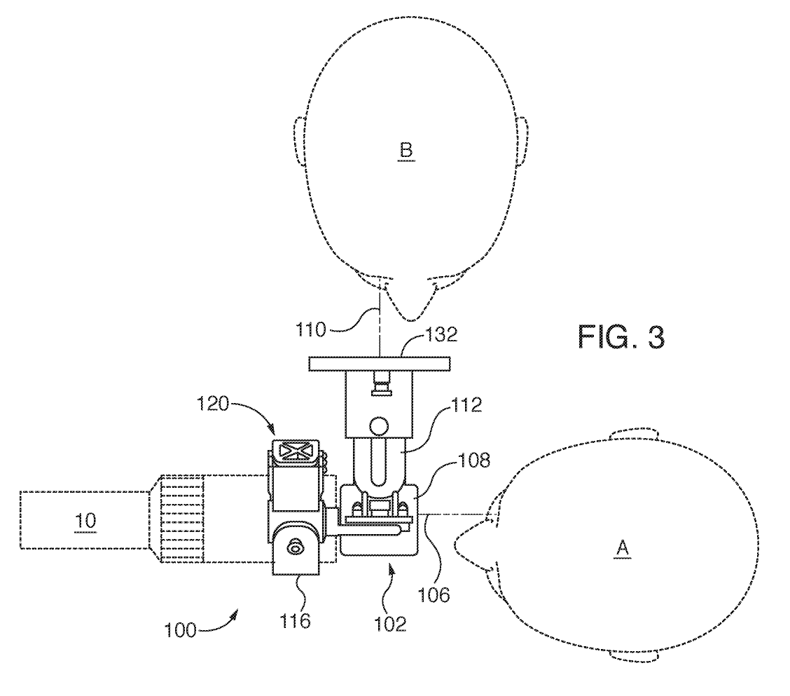

FIG. 3 shows a significant advantage of the present invention. While user A is sighting using scope 10, an observer B standing to the side is able to observe what user A sees in scope 10. Observer B may be a coach or instructor, and may give instructions to user A, who may be a student. It will be seen in FIG. 3 that dock 130 has been removed. If dock 130 were installed, as shown in FIG. 1, the same views would be provided.

If a smartphone or video camera (neither shown) is placed in dock 130 or against adapter 132, imagery captured will be from the same vantage as that of observer B. Where a smartphone is placed into dock 130, the screen of the smartphone may be seen from the same vantage point. Therefore, it is possible to record and transmit in real time views seen by user A of detachable supplementary viewing accessory 100.

FIG. 3 also shows flexible strap 116 closed over saddle 122, although this may be difficult to discern as these components have similar widths.

It will be appreciated that although description of the invention has been presented with reference to application to scope 10 of rifle 12, those of skill in the art will recognize that there has been presented an accessory suitable for other scope type devices, as listed priorly.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A detachable supplementary viewing accessory for a scope device, the detachable supplementary viewing accessory comprising:
a housing containing a splitter beam glass and including a straight first optical path, a first viewing port affording a view of the first optical path, a second optical path arranged at a right angle or an oblique angle to the first optical path, and a second viewing port affording a view of the second optical path, wherein the first optical path and the second optical path diverge at the splitter beam glass and provide identical views; and
a mount attachable to the housing and including a connector adapted to secure the housing to the scope device, the connector having a grasping element capable of engaging and tightening over scopes of different dimensions.

2. The detachable supplementary viewing accessory of claim 1, wherein the grasping element comprises a flexible strap configured to engage the scope by encirclement.

3. The detachable supplementary viewing accessory of claim 2, wherein the flexible strap includes ratchet teeth, and the mount comprises a ratchet mechanism adapted to retain the flexible strap on the scope.

4. The detachable supplementary viewing accessory of claim 1, wherein the mount further comprises a saddle having an abutment surface abutting the scope when the detachable supplementary viewing accessory is mounted to the scope, and wherein the saddle is attachable directly or indirectly to the housing.

5. The detachable supplementary viewing accessory of claim 4, further comprising a deformable cushion lining the abutment surface of the saddle, for improving conformity of the saddle with an external surface of the scope when the detachable supplementary viewing accessory is mounted to the scope.

6. The detachable supplementary viewing accessory of claim 4, further comprising a rigid support bar attachable to the saddle and to the housing and configured to space the mount away from the housing.

7. The detachable supplementary viewing accessory of claim 1, further comprising a dock for an electronic communications device having a camera, wherein the dock is located and configured such that light from the second optical path will enter the camera.

8. The detachable supplementary viewing accessory of claim 7, wherein the dock is configured to receive and support a smartphone.

9. The detachable supplementary viewing accessory of claim 7, further comprising an adapter configured to slide along the second viewing port and to thereby adjust proximity of the dock from the second viewing port.

10. The detachable supplementary viewing accessory of claim 9, further comprising a securement element adjustable to lock the adapter at a selected location along the second viewing port.

11. The detachable supplementary viewing accessory of claim 1, further comprising a dust cap removably attachable to the first viewing port by snap fit.

12. The detachable supplementary viewing accessory of claim 1, further comprising a housing positional adjustment feature enabling the housing be centered on scopes of different dimensions.

13. The detachable supplementary viewing accessory of claim 12, further comprising a rigid support bar attachable to the saddle and to the housing and configured to space the mount away from the housing, wherein the housing positional adjustment feature comprises a long hole formed in one of the support bar and the housing, and a setscrew configured to pass through the long hole and to thread into the other one of the support bar and the housing.
